(19) United States
(12) Patent Application Publication
(10) Pub. No.: US 2022/0355449 A1
(43) Pub. Date: Nov. 10, 2022

(54) COMBUSTION ASSISTED SLEDGE TOOL

(71) Applicant: Coburn Greiner, Papillion, NE (US)

(72) Inventor: Coburn Greiner, Papillion, NE (US)

(21) Appl. No.: 17/740,824

(22) Filed: May 10, 2022

Related U.S. Application Data
(60) Provisional application No. 63/186,435, filed on May 10, 2021.

(51) Int. Cl. B25B 27/00; B25D 1/00

(52) U.S. Cl. CPC B25B 27/0085; B25D 1/00

(57) ABSTRACT

Systems and methods for propelling a sledge head relative to a sledge body mounted to a handle are described. In an aspect, the sledge head is propelled from a sledge body through action of one or more pistons that are driven through combustion or ignition of charges secured within the sledge body. The charges can be activated based on contact between the sledge head and a working surface to engage one or more charges against a firing pin resulting in combustion or ignition of the charges. The tool can include one or more springs to bias the sledge head toward a retracted position, where activation of the one or more charges overcomes the spring bias to propel the sledge head against the working surface upon contact.

### CROSS-REFERENCE TO RELATED APPLICATIONS

The present application claims the benefit of 35 U.S.C. § 119(e) of U.S. Provisional Application Ser. No. 63/186,435, filed May 10, 2021, and titled “COMBUSTION ASSISTED SLEDGE TOOL.” U.S. Provisional Application Ser. No. 63/186,435 is herein incorporated by reference in its entirety.

### BACKGROUND

Hammers are used in many applications to apply forces from a hammer head mounted to a shaft against a working surface through rotation or other movements of the hammer head. Sledgehammers are a type of tool that can include a handle suitable for two-handed operation of the tool and can be used for a variety of applications, such as demolition and construction.

### SUMMARY

Systems and methods for propelling a sledge head relative to a sledge body mounted to a handle are described. In an aspect, a sledge head for a combustion powered tool includes, but is not limited to, a sledge body configured to couple with a handle for handheld operation of the tool, the sledge body defining a piston cavity and a charge cavity in an axial arrangement, the charge cavity configured to receive a combustible charge; a piston positioned within the piston cavity, the piston configured for translational movement within the piston cavity; a charge plate coupled to the sledge body in an axially rearward position from the charge cavity, the charge plate axially slidable between a forward position and a rear position, the charge plate biased in the forward position via at least one spring to push the combustible charge against the piston; a firing pin coupled to the sledge body adjacent the combustible charge, the firing pin isolated from the combustible charge with the charge plate in the forward position; and a blast plate coupled to an end of the piston to support the blast plate adjacent an exterior surface of the sledge body, the blast plate having an interior surface that is spaced apart from the exterior surface of the sledge body by a gap with the piston in a neutral position within the piston cavity, wherein at least a portion of the interior surface of the blast plate contacts at least a portion of the exterior surface of the sledge body with the piston in a firing position within the piston cavity to push the charge plate to the rear position, permitting contact between the combustible charge and the firing pin, wherein gases expelled from combustion of the combustible charge push the piston from the firing position outwards to expel the blast plate outwards relative to the sledge body.

In an aspect, a combustion-assisted sledge tool includes, but is not limited to, a handle; and a sledge head coupled with the handle for handheld operation of the tool, the sledge head including a sledge body defining a piston cavity and a charge cavity in an axial arrangement, the charge cavity configured to receive a combustible charge, a piston positioned within the piston cavity, the piston configured for translational movement within the piston cavity, and a blast plate coupled to an end of the piston to support the blast plate adjacent an exterior surface of the sledge body, the blast plate having an interior surface that is spaced apart from the exterior surface of the sledge body by a gap with the piston in a neutral position within the piston cavity, wherein at least a portion of the interior surface of the blast plate contacts at least a portion of the exterior surface of the sledge body with the piston in a firing position within the piston cavity, wherein gases expelled from combustion of the combustible charge push the piston from the firing position outwards to expel the blast plate outwards relative to the sledge body.

In an aspect, a sledge head for a combustion-assisted tool includes, but is not limited to, a sledge body configured to couple with a handle for handheld operation of the tool, the sledge body defining a piston cavity and a charge cavity in an axial arrangement, the charge cavity configured to receive a combustible charge; a piston positioned within the piston cavity, the piston configured for translational movement within the piston cavity; and a blast plate coupled to an end of the piston to support the blast plate adjacent an exterior surface of the sledge body, the blast plate having an interior surface that is spaced apart from the exterior surface of the sledge body by a gap with the piston in a neutral position within the piston cavity, wherein at least a portion of the interior surface of the blast plate contacts at least a portion of the exterior surface of the sledge body with the piston in a firing position within the piston cavity, wherein gases expelled from combustion of the combustible charge push the piston from the firing position outwards to expel the blast plate outwards relative to the sledge body.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DRAWINGS

The Detailed Description is described with reference to the accompanying figures. In the figures, the use of the same reference numbers in different instances in the description and the figures may indicate similar or identical items.

FIG. 1 is an isometric view of a sledge tool in accordance with example embodiments of the present disclosure.

FIG. 2 is a cross-sectional side view of the sledge tool of FIG. 1.

FIG. 3 is a rear view of the sledge tool of FIG. 1, with a lock plate shown in a safety position, in accordance with example embodiments of the present disclosure.

FIG. 4 is a cross-sectional side view of the sledge tool of FIG. 1, with the lock plate shown in a firing position, in accordance with example embodiments of the present disclosure.

FIG. 5 is a cross-sectional side view of the sledge tool of FIG. 1, shown in an in-contact configuration upon impact of a blast plate with a surface, in accordance with example embodiments of the present disclosure.

FIG. 6 is a cross-sectional side view of the sledge tool of FIG. 1, shown in a firing configuration following impact of the blast plate with the surface, in accordance with example embodiments of the present disclosure.

FIG. 7 is a cross-sectional side view of the sledge tool of FIG. 1, shown in a retracting configuration following firing of the blast plate, in accordance with example embodiments of the present disclosure.

FIG. 8A is an isometric view of a charge holder of the sledge tool of FIG. 1, shown in an empty configuration with no charge inserted.

FIG. 8B is an isometric view of an ejection system of the sledge tool of FIG. 1, shown in a loaded configuration with a charge inserted ready for ejection, in accordance with example embodiments of the present disclosure.

### DETAILED DESCRIPTION

### Overview

Sledgehammers and other impact tools are utilized in a variety of industries and applications to deliver powerful forces from impact of the sledge head against working surfaces, such as for demolition projects, construction projects, search and rescue operations, military operations, police and fire operations, and the like. Many sledge tools include the sledge head mounted to a shaft having a length suitable for two-handed grip and operation of the sledge, which can provide mechanical advantage over shorter levered tools. However, such configurations have impact forces that are limited to the strength and coordination of the operator and can require great physical exertion to operate. Moreover, automated sledge devices are typically bulky or otherwise relatively immobile and unsuited for many field operations.

Accordingly, the present disclosure is directed, at least in part, to systems and methods for providing a sledge tool having a propelled sledge head that is moveable relative to a sledge body mounted to a handle. In an aspect, the sledge body defines a cavity to house one or more pistons coupled to a blast plate that forms at least a portion of a front of the sledge head. The sledge body also defines a cavity to house one or more charges that direct a propulsion of gases towards the one or more pistons to propel the blast plate from the sledge body. The piston cavity can include one or more exhaust ports through which the gases can be ejected from the sledge body following propulsion of the blast plate. The blast plate can then be returned to a starting position though action of a spring or other biasing device. The sledge body can be coupled with a breech plate to secure the charges within the sledge body, where the breech plate is moveable to discharge spent charge portions and introduce new charge portions into the sledge body. The sledge tool can include one or more safety features to prevent activation of the charges, for example, by preventing rear movement of the blast plate towards a firing pin, by removing the firing pin from proximity with the charges, or combinations thereof.

The sledge tool provides a lightweight sledge device that can be actuated with shotgun-shell-sized charges that can be carried, loaded, and fired by a single user. As the user causes contact between a working surface and the blast plate, the sledge tool provides additional force against the working surface through combustion-based propulsion of the blast plate from the sledge body. The sledge tool provides a contact physical force of a sledgehammer face against a working surface (e.g., via contact between the blast plate and the working surface without activation of the charges) and additional force against the working surface upon impact (e.g., via propulsion of the blast plate via activation of the charge(s)).

### Example Implementations

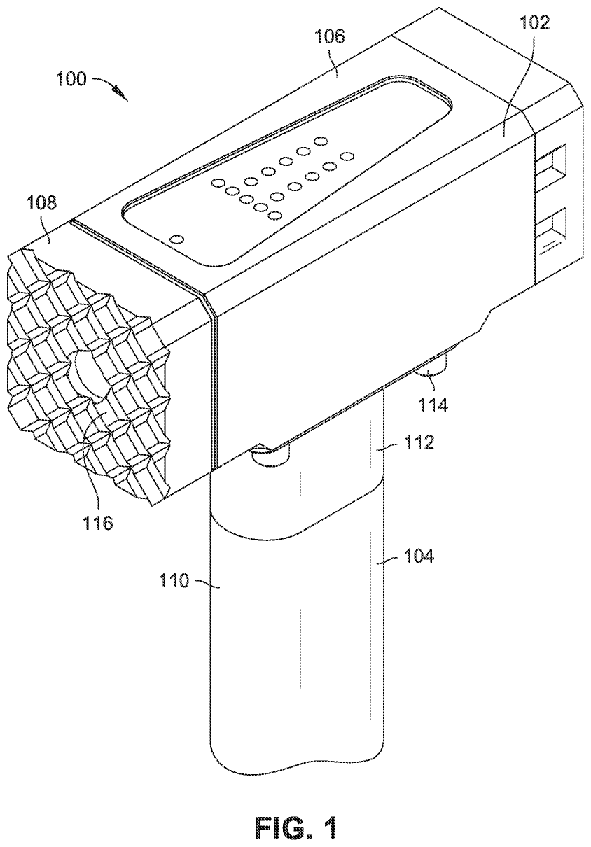

Referring to FIGS. 1 through 8B, example implementations of a sledge tool (hereinafter referred to as “tool 100”) are provided. The tool 100 generally includes a sledge head 102 configured to be mounted to a handle 104 to swing the sledge head 102 into contact with a working surface (e.g., a surface to be struck by the sledge head 102). The sledge head 102 includes a sledge body 106 coupled with a blast plate 108 that is extendable relative to the sledge body 106 to act upon the working surface following impact between the sledge head 102 and the working surface, as described further herein. The handle 104 is secured to the sledge head 102 in a substantially fixed configuration to prevent movement between the handle 104 and the sledge head 102. For example, an end 110 of the handle 104 can be received in a holder 112 coupled with the sledge body 106 via one or more fasteners 114 (e.g., pins, screws, bolts, etc.). Alternatively or additionally, portions of the holder 112 or the handle 104 can be integrally formed with the sledge body 106, such as through unitary construction techniques.

The sledge head 102 can be formed with varying shapes and sizes to facilitate impact of the blast plate 108 against the working surface and to absorb the forces associated with such impact and with combustion of one or more charges within the sledge body 106 used to propel the blast plate 108 outwards from the sledge body 106. For example, in an implementation the sledge body 106 and the blast plate 108 have similarly-dimensioned cross-sections having generally rectangular shapes (e.g., with beveled edges), however the tool 100 is not limited to such configuration. For instance, it can be appreciated that the sledge body 106, the blast plate 108, or both can be formed in any shape or profile including, but not limited to, planar shapes, irregular shapes, shapes having one or more protrusions, and the like.

In general, the sledge head 102 can be constructed of durable materials to absorb the forces associated with impact of the blast plate 108, with contact between the blast plate 108 and the sledge body 106, and with combustion of one or more charges within the sledge body 106. For example, the sledge head 102 can be formed from materials including, but not limited to, metals, metal composites, metal alloys, plastics, plastic composites, stone, ceramics, or the like. In implementations, the blast plate 108 and the sledge body 106 are formed from the same material. In implementations, the blast plate 108 and the sledge body 106 include one or more differing materials with respect to each other. For example, the blast plate 108 can include one or more materials (e.g., as a surface treatment, alloy, etc.) at an impact face 116 that is not included in the sledge body 106. For example, in various aspects, the blast plate 108 is constructed to withstand impact forces between the blast plate 108 and the working surface associated with contact with the impact face 116 and the working surface following propulsion of the blast plate 108 from the sledge body 106, where the sledge body 106 may not be subjected to such forces. Alternatively or additionally, the sledge body 106 can include one or more materials (e.g., as a surface treatment, alloy, etc.) that is not included in the blast plate 108. For example, in various aspects, the sledge body 106 is constructed to withstand combustion of one or more charges within the sledge body 106 that the blast plate 108 is not subjected to. The tool 100 also generally has a weight suitable for hand-held operation of the tool 100. For example, the tool 100 can have a weight from about 5 pounds to about 25 pounds, however the tool 100 is not limited to such weights and can be constructed to have a weight of less than 5 pounds or more than 25 pounds.

The handle 104 can be constructed of durable materials for manipulating the sledge head 102 and to absorb the forces associated with impact of the blast plate 108 with a working surface (e.g., the surface to be impacted by the blast plate 108). For example, in implementations, the handle 104 can be formed from wood, fiberglass, metal, metal composites, plastic, plastic composites, or the like, or combinations thereof. The handle 104 can be configured to support one-handed or two-handed operation of the tool 100. For example, the handle 104 can have a length from about 12 inches to about 48 inches, where the overall length of the tool 100 can depend on clearance of the operating environment of the tool 100, portability considerations, or the like. However, the tool 100 is not limited to such dimensions and can be configured with smaller dimensions (e.g., a handle 104 with a length of less than 12 inches) or larger dimensions (a handle 104 with a length of greater than 48 inches).

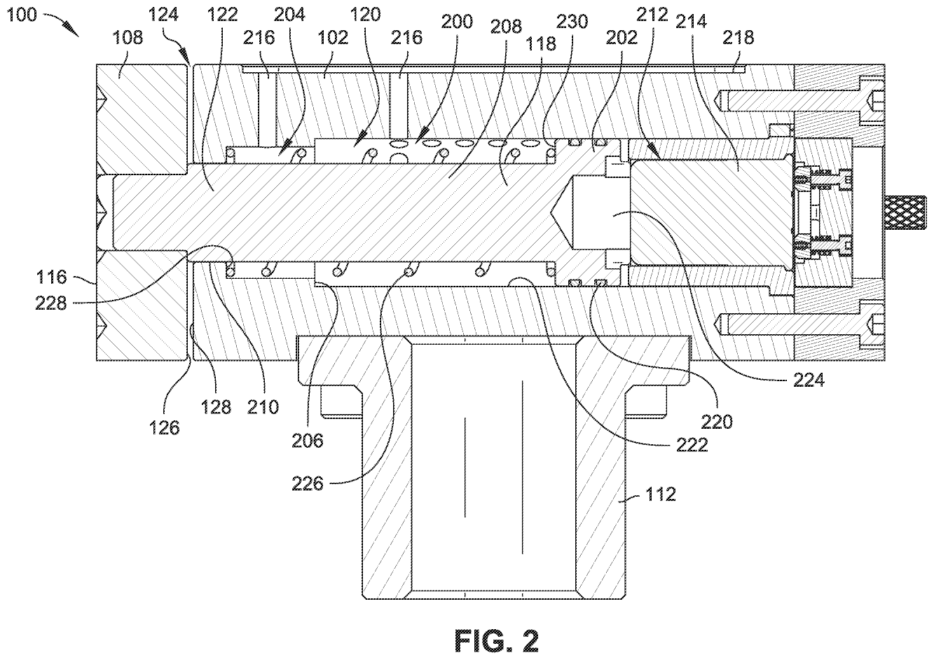

The sledge head 102 supports one or more pistons 118 (e.g., shown in FIG. 2) housed within a piston cavity 120 defined by the sledge body 106. The one or more pistons 118 are coupled with the blast plate 108 at an end 122 of the piston 118, such that translational movement of the piston 118 within the piston cavity 120 moves the blast plate 108 away from or towards the sledge body 106. In implementations, the blast plate 108 can transition between at least three configurations, with a ready configuration, an impact configuration, and a firing configuration. For instance, the sledge head 102 is shown in FIGS. 1, 2, and 4 with the blast plate 108 in a ready configuration in which the blast plate 108 is in a neutral position with a gap 124 present between in interior surface 126 of the blast plate 108 and an exterior surface 128 of the sledge body 106.

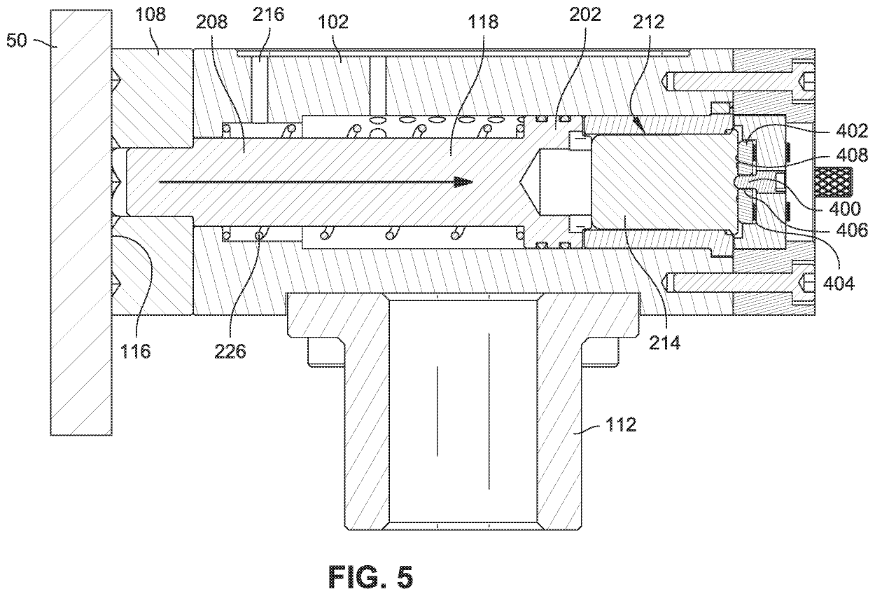

The sledge head 102 is shown in FIG. 5 in an impact configuration in which the blast plate 108 is in contact with a working surface 50 (e.g., with at least a portion of the impact face 116 in contact with the working surface 50). When transitioning between the ready configuration and the impact configuration, the blast plate 108 is moved rearward in closer proximity to the sledge body 106. For example, in the impact configuration, at least a portion of the interior surface 126 of the blast plate 108 contacts at least a portion of the exterior surface 128 of the sledge body 106 to prevent further rearward motion of the blast plate 108. Rearward motion of the blast plate 108 causes rearward motion of the piston 118 within the piston cavity 120, which in turn can cause an interaction between a charge and a firing pin to propel the piston outwards, causing transition from the impact configuration to the firing configuration with outward movement of the blast plate 108 from the sledge body 106, described further herein.

In implementations, the piston cavity 120 includes multiple chambers to facilitate operation of the piston 118. For example, the piston cavity 120 is shown to include a first chamber 200 sized and dimensioned to hold a piston head 202 of the piston 118 within the first chamber 200 and to provide axial translation of the piston head 202 within the first chamber 200. The piston cavity 120 transitions to a second chamber 204 adjacent the first chamber 200 in an axial direction of the piston 118, where the second chamber 204 includes a narrowed cross section compared to the first chamber 200. For example, the transition between the first chamber 200 and the second chamber 204 can include an impact surface 206 against which the piston head 202 can strike to prevent further outward translational movement. The piston 118 can include a rod 208 coupled between the piston head 202 and the blast plate 108, where the rod 208 can transition into the second chamber 204 until the piston head 202 contacts the impact surface 206. In implementations, the impact surface 206 can include a pliable material, such as a rubber washer, gasket, or other material, configured to prevent absorb impact forces between the piston head 202 and the impact surface 206. The piston cavity 120 can transition from the second chamber 204 to a third chamber 210 configured to support the rod 208 as the rod extends beyond the exterior surface 128 of the sledge body 106 during operation of the tool.

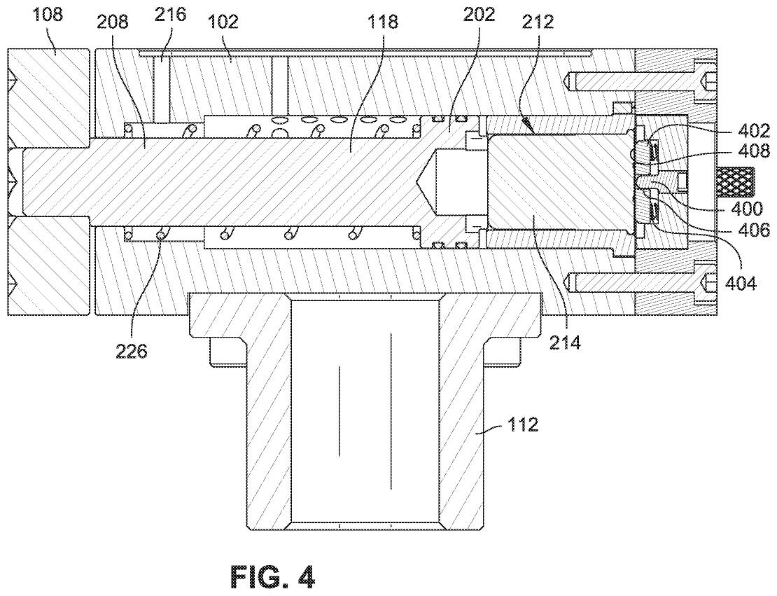

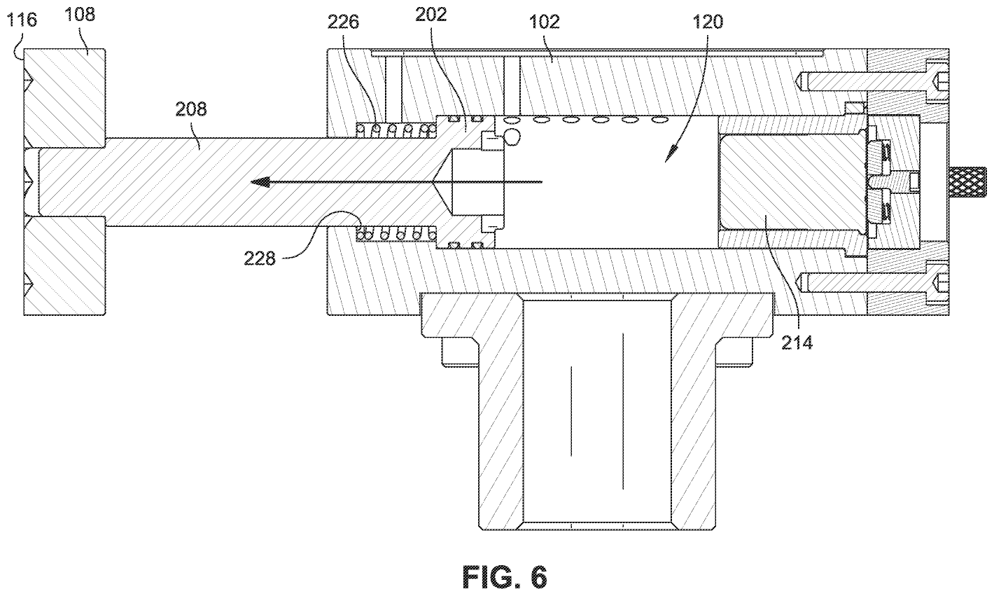

The sledge body 106 also defines a charge cavity 212 configured to hold one or more charges (e.g., shell 214 shown) that, upon activation (e.g., combustion, ignition, etc.) propel gases towards the piston head 202 to drive the piston 118 away from the charge cavity 212 and propel the blast plate 108 outwards from the sledge body 106 to position the blast plate 108 in the firing configuration (e.g., shown in FIG. 6). For example, the sledge head 102 can include one or more firing pins (e.g., pin 400 is shown in FIG. 4) oriented to contact a firing cap of the charges upon impact of the blast plate 108 against the working surface 50. In implementations, the charge cavity 212 is sized to permit translational movement of the charge rearward within the charge cavity 212 to bring the charge in contact with the firing pin. For example, the sledge body 106 is shown with a charge plate 402 positioned rearward from the charge cavity 212 and biased towards the charge cavity 212 via one or more springs 404. The charge plate 402 defines a pin aperture 406 into which the pin 400 extends.

When fully biased by the springs 404, an interior surface 408 of the charge plate 402 extends beyond a tip of the pin 400 in a direction towards the charge cavity 212 to isolate the pin 400 from the firing cap of the shell 214 (e.g., when the tool 100 is in the ready configuration). In implementations, the charge plate 402 in the biased state holds the shell 214 against the piston head 202 when the tool 100 is in the ready configuration. When the blast plate 108 contacts the working surface 50 to push the piston 118 rearward, the piston head 202 contacts the shell 214, which overcomes the bias of the springs 404 and pushes the charge plate 402 rearward, permitting contact between the pin 400 and the shell 214, which results in activation of the charge to drive the piston 118 outwards. In implementations, one or more portions of the interior surface 408 of the charge plate 402 includes a bevel to assist with orienting the shell 214 within the charge cavity 212 (e.g., to prevent jamming of the tool 100).

In example implementations, when the piston 118 pushes the shell 214 against the firing pin 400, the blast cap ignites gunpowder held by the shell 214, resulting in expulsion of gases or other concussive forces from the shell 214 directed towards the piston head 202. In implementations, gases produced by activation of the shell 214 are forced into the piston cavity 120 and push against the piston 118 until expelled from the piston cavity 120. For example, the sledge body 106 can define one or more exhaust ports 216 formed in the sledge body 106 to permit gases to exit the piston cavity 120. The exhaust ports 216 can be formed between various portions of the piston cavity 120 and an upper surface 218 of the sledge body 106. For example, tool 100 is shown with an exhaust port 216 formed between the second chamber 204 the upper surface 218 to permit gases to exit from the second chamber 204, and with a plurality of exhaust ports 216 formed between the first chamber 200 the upper surface 218 to permit gases to exit from the first chamber 204, however the tool 100 is not limited to such configuration of exhaust ports 216 and can include differing configurations. Further, while the exhaust ports 216 are shown formed through an upper portion of the sledge body 106, it can be appreciated that exhaust ports 216 can alternatively or additionally be positioned through one or more sidewalls or other portion(s) of the sledge body 106 to facilitate venting of gases from the piston cavity 120.

The tool 100 can promote the transfer of gases from the shell 214 against the piston head 202 to propel the blast plate 108 outwards. For example, the piston head 202 can include one or more compression rings 220 to interface with an interior surface 222 of the piston cavity 120 to provide a gas-tight barrier between the piston head 202 and the interior surface 222 for gases expelled from the shell 214. In implementations, the piston head 202 defines a cavity 224 aligned with the charge cavity 212 to receive a portion of the gases into an interior of the piston head 202. For example, the cavity 224 can have a substantially conical shape to direct gases into a center of the piston head to promote axial movement of the piston 118 through the piston cavity 120, however the cavity 224 is not limited to a substantially conical shape.

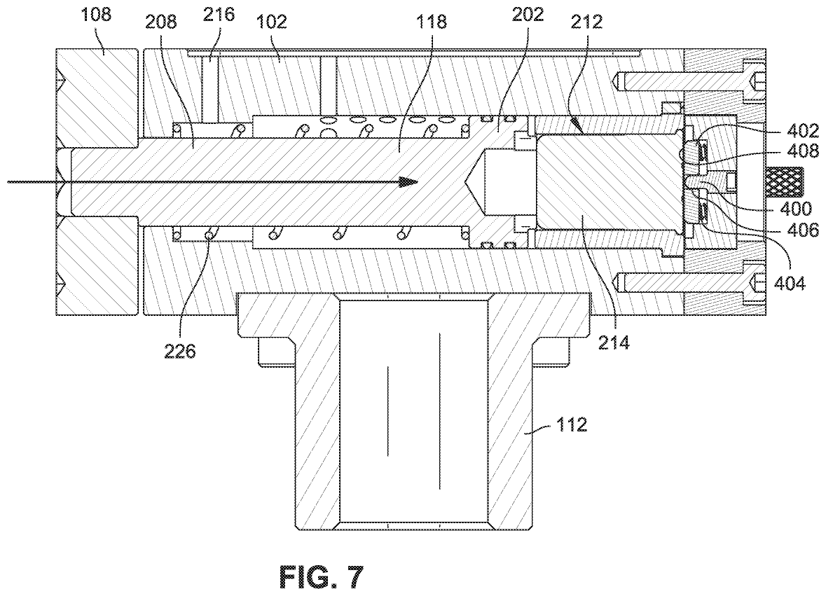

In implementations, the sledge head 102 can include one or more springs that bias the piston 118 within the piston cavity 120 in a direction towards the charge cavity 212. For example, the tool 100 is shown with a spring 226 positioned within the piston cavity 120 between a front surface 228 of the second chamber 204 and a leading surface 230 of the piston head 202 to bias the piston 118 in a direction towards the charge cavity 212. Upon ignition of the charge, the force of the combustion of the charge overcomes the bias force of the spring 226 to propel the piston 118 through the piston cavity 120 until the piston head 202 contacts the impact surface 206, causing the blast plate 108 to extend away from the sledge body 106 (e.g., shown in FIG. 6). The spring 226 can then retract the piston 118 back within the piston cavity 120 follow firing of the blast plate 108, pulling the blast plate 108 back towards the sledge body 106 to reset back into the ready configuration (e.g., shown in FIG. 7). In implementations, the spring 226 extends between the first chamber 200 and the second chamber 204 until compressed substantially entirely within the second chamber 204 upon combustion of the charge.

The charges used in the tool 100 can include, but are not limited to, a shell having a tube, base, and primer, with an explosive charge and packing housed within the tube. In implementations, the explosive charge includes gunpowder and the packing includes a flash-cotton wad made from a material configured to substantially completely burn on ignition (e.g., nitrocellulose). In implementations, the shell includes no shot or other projectiles within the tube or the base. The packing retains the gunpowder within the tube and/or the base until impact between the firing pin of the sledge head 102 and the primer of the charge, wherein ignition of the gunpowder burns the packing and propels the piston 118 within the piston cavity 120 without retaining significant amounts of debris within the piston cavity 120, the charge cavity 212, or the shell 212. In implementations, an end of the shell distal the base is uncrimped to prevent obstruction with the back of the piston head 202 upon firing, where obstruction could cause jamming of the shell within the charge cavity 212 after firing. In implementations, the charges have a length that is less than a length of a traditional shotgun shell. For example, the charge can have a length that is less than about 2.6 in, can have a length that is less than about 1.75 in, can have a length that is about 1.2 in, or the like.

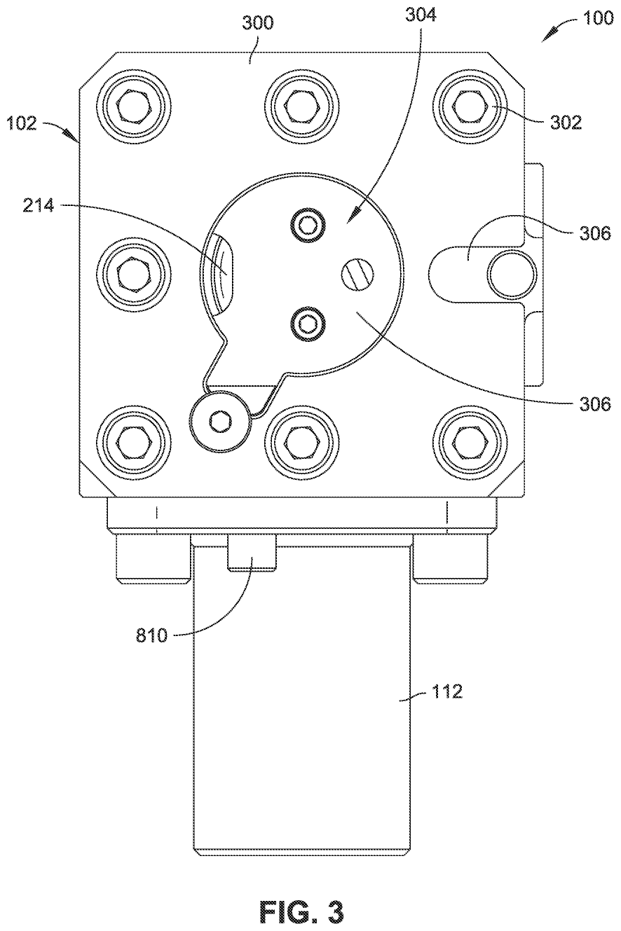

The sledge head 102 can also include a breech plate at a rear portion of the sledge body 106 to provide access to the charge cavity 212 to introduce and remove charges. The breech plate can be provided in various configurations including but not limited to, slidable within a groove, rotatable from a hinge pin secured to a back end of the sledge body 106, hinged from a portion of the sledge body 106, or the like. In an example implementation, the sledge head 102 includes a breach plate 300 secured to a rear end of the sledge body 106 (e.g., as shown in FIG. 3). The breach plate 300 can be fastened to the sledge body 106 via one or more fasteners 302 (e.g., pins, screws, bolts, etc.), can be integrally formed with the sledge body 106, or the like. The breach plate 300 defines an aperture 304 through the breach plate 300 through which the shell 214 can be inserted into or removed from the charge cavity 212. The breach plate 300 also defines a groove into which a slide plate 306 can slide between the charge cavity 212 and the aperture 304 (e.g., slide between a firing position and an open position) to prevent access to the charge cavity 212 when in the firing position and to provide access to the charge cavity 212 when in the open position. In implementations, the slide plate 306 is coupled with each of the firing pin 400 and the charge plate 402 to slide the firing pin 400 and the charge plate 402 into and out of alignment with the shell 212. For example, the tool 100 can prevent accidental discharge of the charges when the slide plate 306 is positioned in an open configuration, to misalign the firing pin 400 and the blasting cap of the shell 212. In implementations, the slide plate 306 and the charge plate 402 define an aperture through which the shell 214 can be seen when in a safety position (e.g., not fully slid into the firing position), as shown in FIG. 3.

Alternatively or additionally, the tool 100 can include a safety latch positioned between a portion of the blast plate 108 and the sledge body 106 to prevent full rearward motion of the blast plate 108, which prevents full rearward motion of the piston 118 to avoid interaction between the firing pin and the charge. In implementations, the breech plate 300 can include a twist-lock plunger pin that moves the firing pin into and out from firing position based on rotation, for example, by retracting the firing pin from the rear of the sledge body 106 when the plunger pin is in an open position, preventing contact between the firing pin and the charge, and bringing the firing pin into a firing configuration when the plunger pin is in a closed configuration.

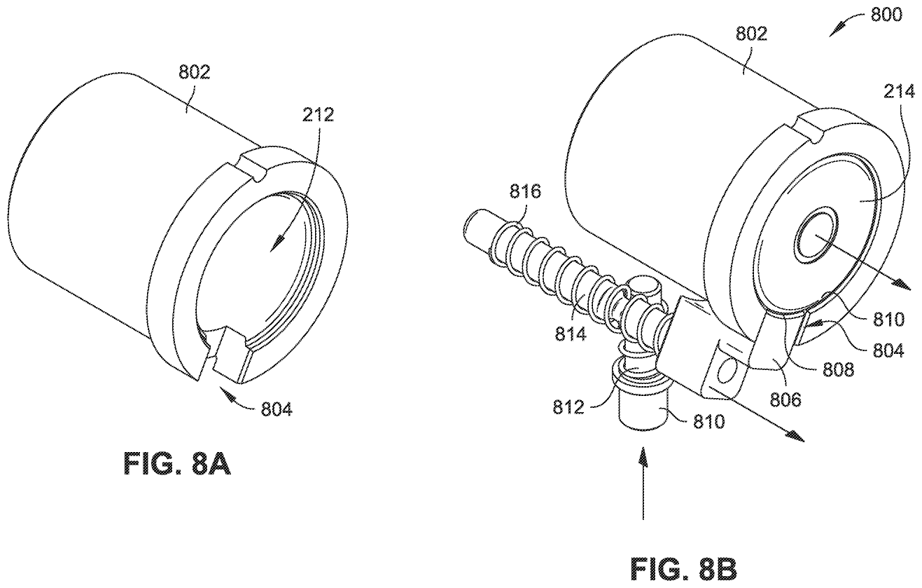

The tool 100 can include an ejection system to remove charges from the charge cavity 212. For example, referring to FIGS. 8A and 8B, the tool 100 is shown including an ejection system 800 configured to remove a shell 214 from a shell holder 802. The shell holder 802 defines the charge cavity 212 in an interior of the shell holder 802, where the shell holder 802 can sit within an interior of the sledge body 106. The shell holder 802 defines a cutout 804 into which a portion of an ejection head 806 can extend. The ejection head 806 can include a lip 808 configured to interface with an edge 810 of the shell 212. For example, the lip 808 can be positioned such that the edge 810 of the shell 212 is positioned between the lip 808 and the charge plate 402, where rearward motion of the ejection head 806 causes the lip 808 to push the shell 212 out of the charge cavity 212 and through the aperture 304 of the breech plate 300.

In implementations, the tool 100 includes an eject button 810 coupled with a button rod 812 to control movement of the ejection head 806. For example, the ejection head 806 can be coupled with an ejection rod 814, each out which is biased rearward by an ejection spring 816. Upon pushing the ejection button 810 towards the sledge body 106, the button rod 812 interfaces with the ejection rod 814 to permit the ejection spring 816 to push the ejection head 806 against the edge 810 of the shell 212 and out of the tool 100 (e.g., via the aperture 304 of the breech plate 300). For example, the button rod 812 and the ejection rod 814 can include tapered regions that, when pushed into proximity with one another, permit rearward motion of the ejection rod 814. It can be appreciated that alternative or additional ejection systems can be utilized for the tool 100 and the tool 100 is not limited to the example ejection system 800 described herein.

### Conclusion

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

1. A sledge head for a combustion-assisted tool, comprising:
a sledge body configured to couple with a handle for handheld operation of the tool, the sledge body defining a piston cavity and a charge cavity in an axial arrangement, the charge cavity configured to receive a combustible charge;
a piston positioned within the piston cavity, the piston configured for translational movement within the piston cavity;
a charge plate coupled to the sledge body in an axially rearward position from the charge cavity, the charge plate axially slidable between a forward position and a rear position, the charge plate biased in the forward position via at least one spring to push the combustible charge against the piston;
a firing pin coupled to the sledge body adjacent the combustible charge, the firing pin isolated from the combustible charge with the charge plate in the forward position; and
a blast plate coupled to an end of the piston to support the blast plate adjacent an exterior surface of the sledge body, the blast plate having an interior surface that is spaced apart from the exterior surface of the sledge body by a gap with the piston in a neutral position within the piston cavity, wherein at least a portion of the interior surface of the blast plate contacts at least a portion of the exterior surface of the sledge body with the piston in a firing position within the piston cavity to push the charge plate to the rear position, permitting contact between the combustible charge and the firing pin, wherein gases expelled from combustion of the combustible charge push the piston from the firing position outwards to expel the blast plate outwards relative to the sledge body.

2. The sledge head of claim 1, wherein the sledge body defines at least one exhaust port extending through the sledge body from the piston cavity to an upper surface of the sledge body to vent gases expelled from combustion from the piston cavity.

3. The sledge head of claim 1, further comprising at least one spring positioned in the piston cavity positioned between the piston and a front surface of the piston cavity to bias the piston rearward towards the charge cavity.

4. The sledge head of claim 3, wherein the piston cavity includes a first chamber and a second chamber having a narrower cross section than the first chamber, the second chamber positioned axially forward from the first chamber, and wherein a transition between the first chamber and the second chamber includes an impact surface against which a piston head of the piston can strike to prevent further outward translational movement.

5. The sledge head of claim 4, wherein the spring is compressed within the second chamber upon contact between the piston head and the impact surface.

6. The sledge head of claim 5, wherein the sledge body defines a first exhaust port extending through the sledge body from the first chamber to an upper surface of the sledge body and a second exhaust port extending through the sledge body from the second chamber to the upper surface of the sledge body to vent gases expelled from combustion from the piston cavity.

7. A combustion-assisted sledge tool, comprising:
a handle; and
a sledge head coupled with the handle for handheld operation of the tool, the sledge head including a sledge body defining a piston cavity and a charge cavity in an axial arrangement, the charge cavity configured to receive a combustible charge,
a piston positioned within the piston cavity, the piston configured for translational movement within the piston cavity, and
a blast plate coupled to an end of the piston to support the blast plate adjacent an exterior surface of the sledge body, the blast plate having an interior surface that is spaced apart from the exterior surface of the sledge body by a gap with the piston in a neutral position within the piston cavity, wherein at least a portion of the interior surface of the blast plate contacts at least a portion of the exterior surface of the sledge body with the piston in a firing position within the piston cavity, wherein gases expelled from combustion of the combustible charge push the piston from the firing position outwards to expel the blast plate outwards relative to the sledge body.

8. The combustion-assisted sledge tool of claim 7, further comprising a firing pin coupled to the sledge body adjacent the combustible charge, the firing pin configured to strike the combustible charge with the piston in the firing position within the piston cavity.

9. The combustion-assisted sledge tool of claim 7, further comprising a charge plate coupled to the sledge body in an axially rearward position from the charge cavity, the charge plate biased in a forward position to push the combustible charge against the piston.

10. A sledge head for a combustion-assisted tool, comprising:
a sledge body configured to couple with a handle for handheld operation of the tool, the sledge body defining a piston cavity and a charge cavity in an axial arrangement, the charge cavity configured to receive a combustible charge;
a piston positioned within the piston cavity, the piston configured for translational movement within the piston cavity; and
a blast plate coupled to an end of the piston to support the blast plate adjacent an exterior surface of the sledge body, the blast plate having an interior surface that is spaced apart from the exterior surface of the sledge body by a gap with the piston in a neutral position within the piston cavity, wherein at least a portion of the interior surface of the blast plate contacts at least a portion of the exterior surface of the sledge body with the piston in a firing position within the piston cavity, wherein gases expelled from combustion of the combustible charge push the piston from the firing position outwards to expel the blast plate outwards relative to the sledge body.

11. The sledge head of claim 10, further comprising a firing pin coupled to the sledge body adjacent the combustible charge, the firing pin configured to strike the combustible charge with the piston in the firing position within the piston cavity.

12. The sledge head of claim 10, further comprising a charge plate coupled to the sledge body in an axially rearward position from the charge cavity, the charge plate biased in a forward position to push the combustible charge against the piston.

13. The sledge head of claim 12, further comprising a firing pin coupled to the sledge body adjacent the combustible charge, wherein the charge plate defines an aperture into which the firing pin extends, and wherein the forward position of the charge plate isolates the firing pin from the combustible charge.

14. The sledge head of claim 13, wherein the charge plate is biased in the forward position via at least one spring to push the combustible charge against the piston, and wherein contact between the blast place and a working surface causes rearward motion of the piston to overcome the bias of the at least one spring to introduce the combustible charge to the firing pin.

15. The sledge head of claim 10, wherein the sledge body defines at least one exhaust port extending through the sledge body from the piston cavity to an upper surface of the sledge body to vent gases expelled from combustion from the piston cavity.

16. The sledge head of claim 10, further comprising at least one spring positioned in the piston cavity positioned between the piston and a front surface of the piston cavity to bias the piston rearward towards the charge cavity.

17. The sledge head of claim 16, wherein the piston cavity includes a first chamber and a second chamber having a narrower cross section than the first chamber, the second chamber positioned axially forward from the first chamber, and wherein a transition between the first chamber and the second chamber includes an impact surface against which a piston head of the piston can strike to prevent further outward translational movement.

18. The sledge head of claim 17, wherein the spring is compressed within the second chamber upon contact between the piston head and the impact surface.

19. The sledge head of claim 17, wherein the sledge body defines a first exhaust port extending through the sledge body from the first chamber to an upper surface of the sledge body and a second exhaust port extending through the sledge body from the second chamber to the upper surface of the sledge body to vent gases expelled from combustion from the piston cavity.

20. The sledge head of claim 10, further comprising a slide plate coupled with a firing pin, the slide plate configured to slidable move the firing pin into and out of axial alignment with the combustible charge within the charge cavity.
